(19) United States
(12) Patent Application Publication
(10) Pub. No.: US 2008/0046511 A1
(43) Pub. Date: Feb. 21, 2008

(54) System and Method for Conducting an Electronic Message Forum

(76) Inventor: Richard Skrenta, San Carlos, CA (US)

Correspondence Address: SHEMWELL MAHAMEDI LLP, 4880 STEVENS CREEK BOULEVARD, SUITE 201, SAN JOSE, CA, 95129, US

(21) Appl. No.: 11/464,813

(22) Filed: Aug. 15, 2006

(51) Int. Cl. G06F 15/16

(52) U.S. Cl. 709/204; 709/206

(57) ABSTRACT

An electronic message forum is operated by receiving a communication from an individual. The communication includes a content for the electronic message forum. For example, the content may correspond to text and/or images, authored or selected by the individual. Information about the communication or the individual making the post is programmatically determined. The information does include personal identifiable information about the individual. A message is posted on the forum that is based on the content of the communication on the electronic message forum. In posting the message, the programmatically displayed information is provided with the posted message.

### TECHNICAL FIELD

The disclosed embodiments relate generally to the field of electronic messages, and more particularly, to a system and method for conducting an electronic message forum.

### BACKGROUND

Electronic message forums are widespread with the evolvement of the Internet. In general, such forums are hosted at a web site, and enable individuals to post a message that can be viewed by others who visit the web site. It is common practice to allow posters to view and read messages from others, to post replies to messages, and to create a topic that others can post replies to. Messaging forums may be conducted to be available to the general public, or they may have restricted access. For example, some messaging forums require individuals to create an account, and to log-in before posting a message.

Electronic message forums provide a medium by which individuals can post opinions, place advertisements, solicit services, and offer items for sale. Users generally rely on text, although it is possible to insert images, media, links and other content. Many web sites that provide news, reports, blogs, and other content offer individuals the opportunity to make a comment after reading or viewing a particular item. In many cases, the responding poster can be totally anonymous when posting a message, and the host of the forum has to employ different mechanisms to monitor the content of posters (e.g. a person who is also a board monitor). Most message forums have an explicit terms and conditions regulating what individuals may say in their messages, and if the content of the messages is deemed to run afoul of the terms and conditions, the moderator or administrator of the message forum may remove the message.

### BRIEF DESCRIPTION OF THE DRAWINGS

FIG. 1 illustrates a data flow process for conducting an electronic message board, under an embodiment of the invention.

FIG. 2 illustrates a system for conducting an electronic message board in which geographic information about a physical location of the poster is programmatically determined and rendered, under an embodiment of the invention.

FIG. 3 illustrates a method for conducting an electronic message board in which information derived from a communication submitting a post is used to supplement the post, under an embodiment of the invention.

FIG. 4 illustrates such an implementation of an electronic message forum, under an embodiment of the invention.

### DETAILED DESCRIPTION

Embodiments described herein enable an electronic message forum to be conducted in a manner where information about individual posters is programmatically determined and displayed with messages authored or created by those posters. According to an embodiment, the information that is determined excludes information that could potentially be used to uniquely identify the person. For example, the information determined about the user would exclude information typically referred to as personal indentifiable information (PII). In one embodiment, the information determined about individual posters is geographic information, and an identification of a physical location of the poster (e.g. city, state, country, zip code) is displayed with a message of the poster.

As used herein, an electronic message forum includes any online forum in which an individual can create or specify content and have that content rendered for any member of the public, or any member of a class of individuals, who accesses the online forum. Electronic forums may employ templates, guidelines and enable individuals to include different kinds of functionality. Specific examples of online message forums include message boards on which opinions are posted, “electronic classifieds”, online auctions, blog commentaries, and online reviews.

One or more embodiments contemplate message forums that are anonymous, or alternatively, partially anonymous. For example, some message forums may enable individuals to post opinions with complete anonymity, while commercial forums enable individuals to provide items for sale or on auction using identifiers that are aliases, but still unique to an individual or entity. In the latter case, the poster may be uniquely identified by an online identifier, that in certain cases, can be used to determine the true identity of the poster. For example, on online auction sites, the identities of the sellers are unique aliases, which can in certain cases be used to reveal the true identity of the poster.

Examples of the type of information that may be considered PII (and thus potentially excluded from information that is determined about an individual poster) may include an identifying name (e.g. surname), an email address, or a numeric identifier that is unique to the individual (e.g. social security number, driver's license, credit card number). Otherwise, information that may be determined about a given poster may, depending on various embodiments, include geographic location or residence of the individual (e.g. city, state, country, country, zip code) or information that classifies that individual with other people (e.g. age or gender classification, or other classification based on demographics).

Under an embodiment, an electronic message forum is operated by receiving a communication from an individual. The communication includes a content for the electronic message forum. For example, the content may correspond to text and/or images, authored or selected by the individual (e.g. an opinion, or a solicitation to buy or sell an item). Information about the communication or the individual making the post is programmatically determined. The information does include personal identifiable information about the individual. A message is posted on the electronic message forum that is based on the content of the communication. The programmatically displayed information is then provided (e.g. displayed or made available) with the posted message.

According to another embodiment, a communication containing a content for a message on the electronic message forum is received. A network address used to send the communication is identified. Geographic information associated with the network address is determined, and the message is posted on the electronic message forum. With the message, an identification of a location of the poster is provided. The identification is based on the geographic information determined from the network address.

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using modules. A module may include a program, a subroutine, a portion of a program, or a software component or a hardware component capable of performing one or more stated tasks or functions. As used herein, a module can exist on a hardware component independently of other modules, or a module can be a shared element or process of other modules, programs or machines.

Furthermore, one or more embodiments described herein may be implemented through the use of instructions that are executable by one or more processors. These instructions may be carried on a computer-readable medium. Machines shown in figures below (e.g. forum server 200) provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on many cell phones and personal digital assistants (PDAs)), and magnetic memory. Computers, terminals, network enabled devices (e.g. mobile devices such as cell phones) are all examples of machines and devices that utilize processors, memory, and instructions stored on computer-readable mediums.

Overview

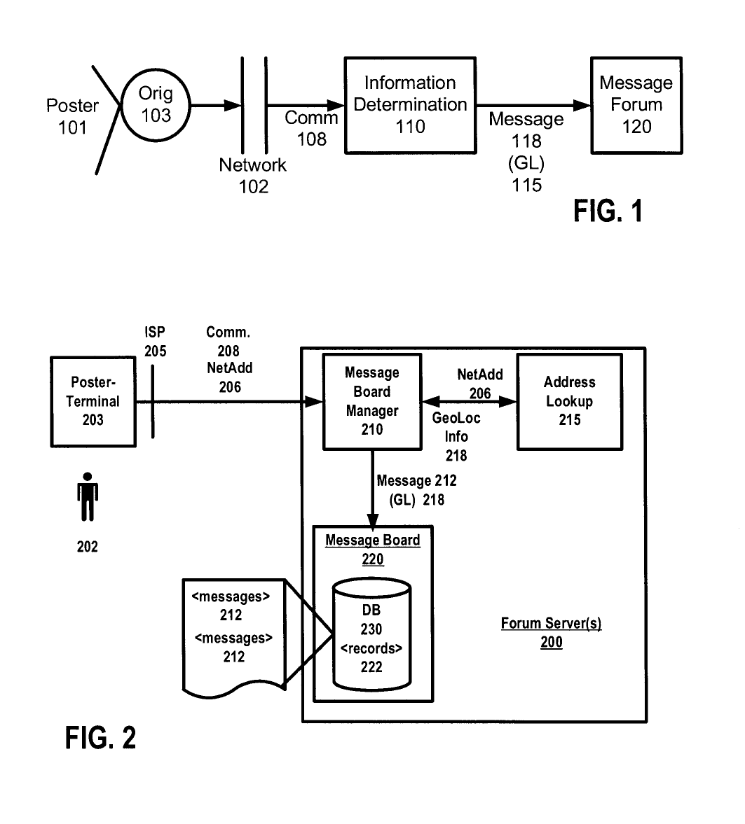

FIG. 1 illustrates a data flow process for conducting an electronic message board, under an embodiment of the invention. In an embodiment of FIG. 1, an information determination component 110 is used in connection with an electronic message forum 120. Such components described with FIG. 1 may be implemented in the form of modules or other programmatic components. In one implementation, electronic message forum 120 may be hosted on a network site, such as at a website. The combination of the electronic message forum 120 and determination component 110 may be operated on one or more servers, hosted on one or more online domains. The forum 120 enables individuals to compose messages for the general public, or for a specific class of users of the forum (e.g. registered users, invited users). In one implementation, the forum 120 may post messages from a user by making the messages renderable on a web page that an individual can view using a web browser. The web page may be provided at a network location on the domain of the forum 120, which the user can access using a web browser.

A format of posted messages on forum 120 may correspond to text, although images and media be included. A poster 101 may also insert links to other network locations or sites where other content is provided. The message forum 120 may be provided in various different context and implementations. For example, message forum 120 may be provided on a web site that is dedicated to providing message forums. Alternatively, the message forum 120 may be integrated into a web page, such as on a blog or home web page. Still further, one or more embodiments contemplate use of numerous message forums 120 as part of a feature for enable users to interact and discuss current events and news items. In the latter case, individual forums may be associated with news stories or categories, and users may comment by posting messages. Under one conventional approach, the message forum 120 provides a user-interface feature to enable individuals to compose content (e.g. text content) and to upload the content as a message. Such a message may be referred to as a post. The message forum 120 may include user-interface features for enabling individuals to compose reply posts (reply messages to a message or topic already posted) or compose new posts on a given topic.

According to an embodiment, the message forum 120 posts messages 118 that are first processed, scanned or otherwise handled by the information determination component 110. In one implementation, the information determination component 108 may be programmatically integrated with the message forum 120. In another implementation, the information determination component 110 may be provided as separate from the message forum 120. For example, the information determination component 110 may be provided as an independent service, separate from a network site on which the message forum 120 is hosted. The information determination component 110 handles incoming communications 108 carrying message content from a given poster 101. The poster 101 may transmit the communication 108 over a network 102, which may include public data networks such as the Internet. The information determination component 110 uses data provided with the communication 108 to determine information about the poster 101 or the communication 108.

According to one or more embodiments, the information determination component 110 determines information that is not personal identifiable information, but rather is information about an origin 103 of the poster 101 or his/her communication 108. Examples of the type of information that can be determined from communication 108 include geographic information about a physical location of the poster 101, such as the city (or most proximate city or metropolis), state, county or zip code of the poster 101. Alternatively, the determined information about the poster 101 may correspond to a network origin 102, such as the Internet Service Provider, or private/proprietary network used by the poster 101. Still further, the information that can be determined from the communication 108 may also include demographic information or classification, such as age group, or gender.

An embodiment, the information determined by determination component 110 is information that is generated by a source that is external to the terminal from which the message was transmitted. For example, the information may correspond to a network address, generated by an ISP used by the poster 101. Alternatively, the determination component 110 may use programmatic components that reside on the terminal of the user to determine information. For example, the determination component 110 may use a cookie stored on the terminal and used when the terminal accesses a site of the message forum 120. The cookie may store information that the user previously entered about his or her demographic, or the cookie may provide profile information (e.g. web browsing activities) indicating information about the user.

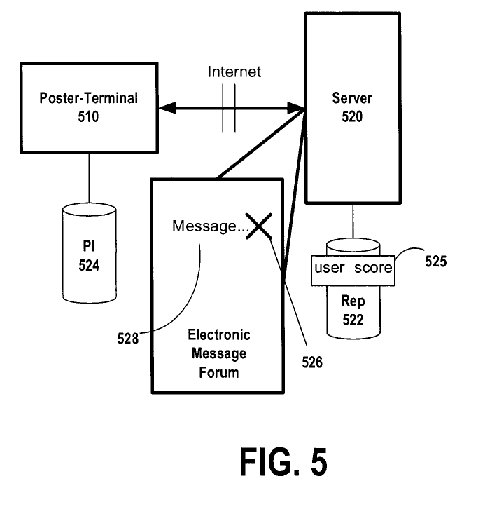

According to an embodiment, the information determined by the determination component 120 is used to supplement the posted message 118. In one embodiment, for example, the posted message 118 is supplemented with geographic information 115 about a physical location of the poster 101. As described with other embodiments, however, other types of information may be used to supplement the posted message 118. In one embodiment, the supplemental information is rendered with the posted message 118. For example, as described with an embodiment of FIG. 4, the supplemental message may be displayed with a moniker or other identifier of the poster 101 (e.g. Fred, Arlington Tex.).

System Architecture

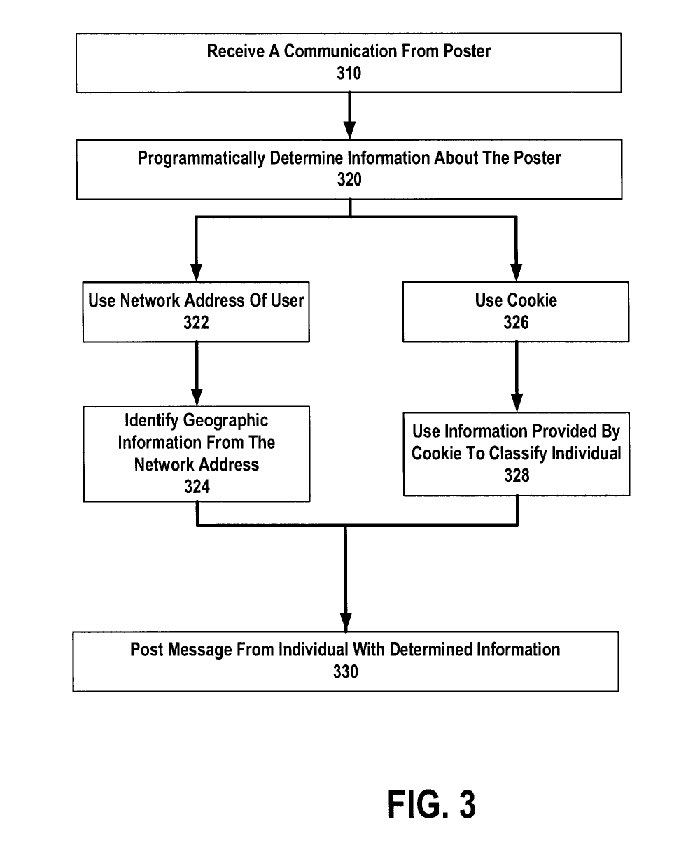

FIG. 2 illustrates a system for conducting an electronic message board in which geographic information about a physical location of the poster is programmatically determined and rendered, under an embodiment of the invention. In an embodiment, a message forum server 200 includes various modules and/or other programmatic components. The forum server 200 may be provided on more than one servers, in various types of architectures. Furthermore, functionality described with forum server 200 may be distributed to multiple locations, and even provided by more than one party. One of the modules or components provided with the forum server 200 is a message board manager 210. The message board manager 210 manages the rendering and use of a message board 212. In an embodiment, the message board 220 is hosted at a network address or domain, and permits user-interaction, including the rendering of messages and the uploading of new messages from posters 202.

In one embodiment, the message board 220 can be rendered in part to provide a web page that displays a plurality of messages 212, where each message 212 corresponds to a record derived from a communication that was once transmitted from an individual poster. The message board 220 may organize messages in various formats, including by category, thread (listing replies), and/or chronologically. The message board 220 may include a database 230 or other data structure that comprises records 222 corresponding to the individual messages 212. In one implementation, the message board manager 210 provides the message board 220 by rendering messages 212 from the records 222 as a web page on the terminal 203 of individual posters 202. The terminal 203 may be configured with a browser or other programmatic component to render the web page. The web page may include features for enabling the user to upload or otherwise provide content for a new message or post on the message board. Such content may be received by the message board manager as communication 208, although other forms of communication or contemplated.

In submitting communication 208 to the forum server 200, the poster 202 may connect the terminal 203 to an ISP 205 (assuming use of the Internet). The ISP 205 may assign a network address 206 to the terminal 203. Such a network address may be static or dynamic. In one embodiment, when poster 202 sends the communication 208 to the forum server 200, data associated with the communication 208 includes the network address 206. The message board manager 210 may be equipped to identify the network address 206 from the communication 208. Under one implementation, a module or component corresponding to information determination component 110 (FIG. 1) may be integrated or otherwise provided with the message board manager 210.

In an embodiment, the message board manager 210 uses a network address lookup 215 to identify a geographic location 218 from the network address 206. The lookup 215 may correspond to a table, or a programmatic component that uses a table or similar data structure. Information for mapping network addresses to geographic locations may derive from various sources. Under one embodiment, such information is provided by third-parties, such as the directory service provided by QUOVA GEOPOINT, provided by QUOVA INC. The geographic location 218 is then provided with the corresponding message 212 on the message board 220. Thus, for example, each record 222 may identify the geographic location 218 that is displayed with the corresponding message rendered from the record. In one implementation, the geographic location 218 is displayed along with a moniker, nickname or other identifier of the poster 202. Thus, for example, the poster 202 may remain anonymous, the forum server 200 may display the city, town or other location information of the poster to provide other viewers of the message board 220 a sense of who the poster is. The geographic location 218 does not identify the poster, thus preserving the poster's anonymity, if so desired.

As an addition or alternative, the message board manager 210 may identify other non-PII information about the poster 202, and use that information to supplement the message 212. For example, the terminal of the poster 203 may include cookies or other programmatic components that the message board manager 210 (or other programmatic component) can retrieve or access. Information provided from the cookie may be used to derive other information which supplements the message 212 authored by that poster 202.

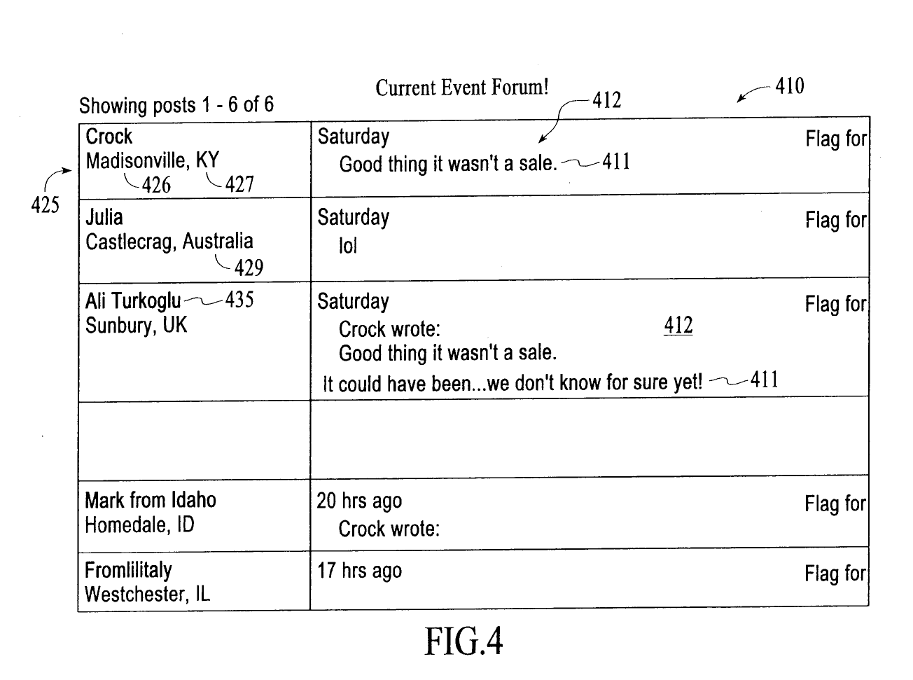

FIG. 3 illustrates a method for conducting an electronic message board in which information derived from a communication submitting a post is used to supplement the post, under an embodiment of the invention. A method such as described by FIG. 3 may be implemented using components described with embodiments such as described with FIG. 2. As such, reference to elements of FIG. 2 is intended to illustrate suitable components for performing a step or sub-step being described.

In a step 310, a communication is received from a poster. In one implementation, the communication may be provided through the poster filling in a form on a web page downloaded on the poster's terminal. The web page may include posts from other users, and include the ability for the user to compose new messages as replies to other messages, or as new topics.

A step 320 provides that information about the poster is programmatically determined. In one embodiment, the information is not personal identifiable information, and thus does not sacrifice the anonymity of the poster. In one embodiment, the information is determined from data created for the poster's communication identifies the origin of the poster, such as the geographic location (or alternatively information about the network location or network used by the poster). In a sub-step 322, the network address of the poster is identified from the communication submitted. Sub-step 324 provides that geographic information is determined from the identified network address. With reference to an embodiment of FIG. 2, the message manager 210 identifies the network address of a communication and uses the lookup 215 to identify geographic information, indicating a physical location of the poster.

In another embodiment, data stored on the poster's terminal may be used to determine information. In one embodiment, a sub-step 326 provides that a cookie (or other data/programmatic element) stored on the user's terminal is accessed. In a sub-step 328, the information provided by that cookie is then used to identify information about the user, such as the user's demographic (age, gender, preferences etc.) or frequency of message board use. The information derived from the cookie may be used to classify the poster, so as to not be uniquely identifiable to the poster.

In a step 330, a message from the individual is posted on the electronic message billboard, with the information determined from step 320. Thus, for example, a user's post may contain a user's moniker or nickname (which the user provides) and a city and/or state of residence. The individual message may be rendered with or without other messages that form the message board. The messages may be renderable to an individual who accesses a network site where the message board is hosted, using, for example, a browser.

Message Board Implementation

FIG. 4 illustrates such an implementation of an electronic message forum, under an embodiment of the invention. In FIG. 4, a message board 410 is renderable on individual terminals in the form of a web page. Individual posts 412 from various authors may be displayed by category of other arrangement. Each post may contain a content 411 provided by an individual poster.

In implementation shown, posters provide their own identifiers or aliases 435. As such, a forum such as illustrated may enable individuals to post anonymously. As described with one or more embodiments, a system that provides the forum may provide additional information about the poster, or alternatively about the origin of the communication, to provide the reader with some information about who authored a particular post. This information is not identifiable or unique to the poster, so as to preserve the poster's anonymity. In an embodiment shown, the information corresponds to geographic information 425 for identifying a location of the poster when making the post. Under an implementation shown by FIG. 4, the geographic information 425 corresponds to a city 426 and state 427 identification, or alternatively to a country 429 (including territory, region or city identification within that country), of the poster. As described elsewhere, the geographic information 425 may be determined from the network address of the communication (i.e. the post) submitted from the poster.

In one alternative variation, the geographic information 425 may be distorted. For example, rather than show the poster as residing in a small town, the geographic information 425 may identify the nearest metropolis or recognizable city and place the poster in that alternative location. This better preservers anonymity, and also provides readers of the post a more familiar location.

As further described elsewhere, other information about the origin of a given post may be displayed. This may include the ISP, or a proprietary network from which the post originated. For example, within local area networks such as provided with enterprises, the network address assigned to individual terminals are internal. But the network itself may have an IP address. In one implementation, a message forum has knowledge of IP addresses belonging to certain enterprises, and lists the name of those enterprises next to the posted messages. For example, the name of a company may be listed next to a posted message, indicating that an origin of a post is within the enterprise network of the particular company.

Use and Display of Profile Information on Message Boards

In addition to geographic information, there is much information that can be determined or identified about a person who posts electronic messages. Such information may include information that is determined from stored information on the user's computer, from information determined programmatically and on-the-fly when the person performs some action (such as open the web page of the electronic message board), or information that is determined from monitoring the user's past actions and activities. Collectively, this information is termed “profile information”.

In one embodiment, information about the user may be stored on the user's computer. This information may correspond to non-personal identifiable information, such as gender, demographic information (race, profession, income level, education). The user may enter this information manually, such as by filling out a form. Alternatively, the some or all of the information may be determined programmatically, such as through use of cookies that identify preferences and activities of the user.

Other information that may be determined programmatically (or through user-input) include, for example, the type of browser or computer the user has installed on his computer, the ISP he or she is using, and the type of Internet connection (e.g. dial-up versus DSL).

Still further, some information may be determined from the user's activities, particularly the user's activities on posting messages on an electronic message board. In one embodiment, a mechanism may be put in place to evaluate the user based on one or more criteria, including: (i) number of times a particular poster has posted a message that has been deleted, deemed in violation of the rules of the message board, or otherwise been the subject of a complaint (“reputation”); (ii) quality of writing, based on sentence structure or vocabulary; (iii) length of the message; or (iv) feedback from other posters (e.g. people who rate the poster).

With regard to reputation information or scoring, the poster needs to be identified so that a reputation score or rank includes reputation information from the user's previous postings. In order to identify the user and correlate the user to past postings, one or more embodiments provide for the following mechanisms to be used: (i) login and password, (ii) moniker identification, (iii) identification through ISP, or (iv) use of cookie or other programmatic/data identifiers on user's terminal.

FIG. 5 illustrates a system in which information displayed about a poster corresponds to profile information about the poster, under an embodiment of the invention. A system such as described with FIG. 5 may be implemented using, for example, a system such as described with FIG. 2. In FIG. 5, profile information is obtained and stored on either a user terminal 510 or a server 520 which hosts an electronic message board 526. Terminal 510 and server 520 may communicate across the Internet. Individuals can access a web site associated with the server 520 to participate in the message forum. In one embodiment, some profile information 524 is stored on the user's terminal 510, while other profile information 524 is maintained server-side. In an implementation shown by FIG. 5, a reputation score 525 is maintained server side about the user. The reputation score 525 may be maintained in a data structure 522 that correlates multiple users, or user terminals, to a particular reputation score. The reputation score 525 may evaluate the poster by, for example, maintaining a count of how often the user has his or her posting deleted, complained about, or how often the poster violated the rules of the message board. To this end, the server 520, or service provided with the server, makes an evaluation of each known individual, based on past instances where events of interest have occurred (e.g. complaints, post deletions by an administrator). The reputation score 525 may be a representation of the evaluation, using such events and past instances. In one implementation, the profile information 524 includes identification (e.g. by way of cookie) of the poster, so that the reputation score 525 can be correlated to the terminal or to the user.

According to one embodiment, when the user posts a message 528, content or information may be added to the post, or otherwise used to affect the post. This information may be in the way of a graphic (e.g. “X” 526), text, or alteration to the user's post, reflecting the user's reputation score 525. Other information from the profile information 524 may also be displayed in connection with a user's profile information 524, such as gender or location.

As an alternative to reputation score, poster's past messages may be evaluated to determine level of interest (e.g. number of times viewed) or quality. Numerous other similar variations may also be implemented, either separately or in connection with one or more other embodiments described herein.

### CONCLUSION

Although illustrative embodiments of the invention have been described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mentioned of the particular feature. This, the absence of describing combinations should not preclude the inventor from claiming rights to such combinations.

What is claimed is:

1. A computer-implemented method for operating an electronic message forum, the method comprising:
receiving a communication from an individual, wherein the communication includes a content for the electronic message forum;
programmatically determining information about at least one of the communication or the individual, wherein the information is not personal identifiable information about the individual;
posting a message based on the content of the communication on the electronic message forum; and
displaying the information with the posted message.

2. The method of claim 1, wherein programmatically determining information about at least one of the communication of the individual includes determining information about an origin of the communication.

3. The method of claim 2, wherein programmatically determining information about an origin of the communication includes determining geographic information about a physical location of the individual when the individual creates the communication.

4. The method of claim 2, wherein programmatically determining information about an origin of the communication includes determining information about a network location of the individual when the individual creates the communication.

5. The method of claim 4, wherein determining information about a network location of the individual includes determining one or more of an Internet Service Provider, private network, or proprietary network that handled the communication from the individual.

6. The method of claim 1, wherein programmatically determining information about at least one of the communication or the individual includes determining the information from data included or associated with the communication.

7. The method of claim 3, wherein determining geographic information about a physical location of the individual when the individual creates the communication includes determining the geographic information using data included or associated with the communication.

8. The method of claim 5, wherein the data included or associated with the communication is a network address of a terminal of the individual.

9. The method of claim 3, wherein determining geographic information about a physical location of the individual when the individual creates the communication includes identifying one or more of a zip code, address, a city, a county, a state, or a country of the individual when the individual created the communication.

10. The method of claim 9, wherein displaying the information with the posted message includes displaying one or more of the zip code, address, city, county, state, or country with the message.

11. The method of claim 4, wherein determining information about a proprietary or private network includes identifying an Internet Service Provider used to handle the communication from the individual.

12. The method of claim 3, wherein posting a message includes posting the message anonymously with the identified geographic information.

13. The method of claim 12, wherein posting the message anonymously with the displayed geographic information includes posting a moniker of the individual.

14. The method of claim 1, wherein programmatically determining information about at least one of the communication or the individual includes determining information using a data structure stored on a terminal of the individual.

15. The method of claim 14, wherein the data structure includes a cookie.

16. The method of claim 14, wherein determining information includes determining information indicating a characteristic or classification of the individual.

17. The method of claim 16, wherein the characteristic corresponds to one or more of a (i) gender of the individual, (ii) age group of the individual, (iii) a web browser that the individual uses, and (iv) type of computer that the individual uses.

18. A computer-implemented method for operating an electronic message forum, the method comprising:
receiving a communication containing a content for a message on the electronic message forum;
identifying a network address used to send the communication;
determining geographic information associated with the network address;
posting the message on the electronic message forum; and
displaying, with the message, an identification of a location based on the geographic information.

19. The method of claim 18, wherein determining geographic information associated with the network address includes determining one or more of a zip code, address, a city, a county, a state, or a country of the individual when the individual created the communication.

20. A computer-readable medium for operating an electronic message forum, the computer-readable medium carrying instructions, that when executed, cause the one or more processors to perform steps comprising:
for each of a plurality of individuals who provide content for the electronic message forum, making an evaluation of one or more messages created by each of those individuals;
receiving, from a terminal operated by a given user, a communication containing a content for a message on the electronic message forum;
determining the evaluation for the given user; and
displaying the message on the electronic message forum with information corresponding to the evaluation.

21. The computer-readable medium of claim 20, wherein instructions for making an evaluation include instructions for determining past instances where messages created by the given user have (i) previously been deleted by an administrator of the electronic message forum, or (ii) deemed in violation of one or more rules of the electronic message forum.

22. The computer-readable medium of claim 21, wherein instructions for making an evaluation include determining a reputation score or indicia for the given user based on a determination of the past instances.

23. The computer-readable medium of claim 22, wherein the reputation indicia corresponds to a graphic displayed with the message on the electronic message forum.

24. The computer-readable medium of claim 21, further comprising instructions for (i) identifying a network address used to send the communication; (ii) determining geographic information associated with the network address; and (iii) displaying, with the message, an identification of a location based on the geographic information.

25. The computer-readable medium of claim 20, wherein instructions for making an evaluation include instructions for determining an interest level one or more past messages of the given user.
